(19) United States
(12) Patent Application Publication
(10) Pub. No.: US 2014/0359317 A1
(43) Pub. Date: Dec. 4, 2014

(54) MOTHERBOARD WITH CONNECTOR COMPATIBLE FOR DIFFERENT INTERFACE STANDARDS

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: KANG WU, Shenzhen (CN); BO TIAN, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/288,609

(22) Filed: May 28, 2014

(30) Foreign Application Priority Data
May 29, 2013 (CN) 2013102044813

(51) Int. Cl. G06F 1/26

(52) U.S. Cl. CPC G06F 1/266
USPC 713/300

(57) ABSTRACT

A motherboard includes a first connector, a first signal module, a second signal module, a power module, and a switch module. The first connector is used to couple external devices to the motherboard. The first signal module and the second signal module are compatible for external devices under different interface standards. The first signal module outputs different signals to control the switch module corresponding to the external device. The switch module connects the first signal module or the second signal module to the first connector corresponding to the control signals received from the control module.

### FIELD

The present disclosure relates to a motherboard.

### BACKGROUND

Typically, a motherboard connector can only communicate with an external device sharing a specific standard.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a motherboard of the present disclosure.

FIG. 2 is a circuit diagram of an embodiment of the motherboard of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The reference “a plurality of” means “at least two.”

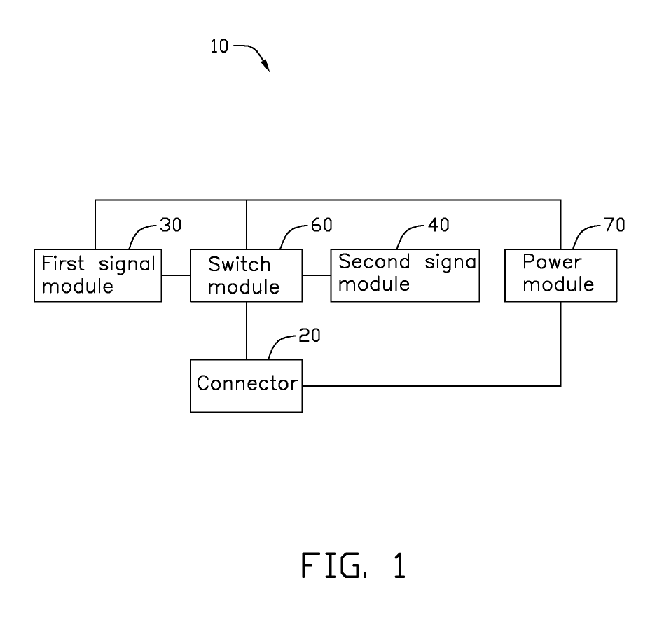

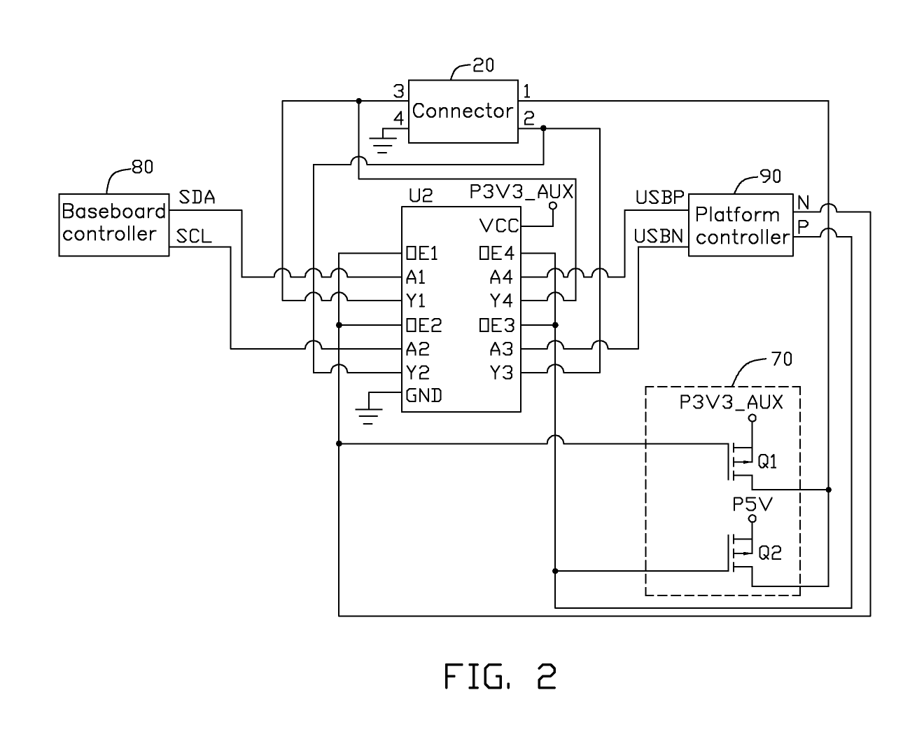

FIG. 1 and FIG. 2 illustrate an embodiment of a motherboard 10 of the present disclosure.

The motherboard 10 can comprise a connector 20, a first signal module 30, a second signal module 40, a switch module 60, and a power module 70. The connector 20, the first signal module 30, and the second signal module 40 are connected to the switch module 60. The power module 70 is coupled to the first signal module 30 and the connector 20.

The switch module 60 comprises a chip U2. The first signal module 30 comprises a platform controller 90. The second signal module 40 comprises a baseboard controller 80. A pin OE1 of the chip U2 and a pin OE2 of the chip U2 are connected to a pin N of platform controller 90. A pin OE3 of the chip U2 and a pin OE4 of the chip U2 are connected to a pin P of the platform controller 90. A pin USBN of the platform controller 90 is connected to a pin A3 of the chip U2. A pin USBP of the platform controller 90 is connected to a pin A4 of the chip U2. A pin SDA of the baseboard controller 80 is connected to a pin A1 of the chip U2. A pin SCL of the baseboard controller 80 is connected to a pin A2 of the chip U2.

The power module 70 comprises electronic switches Q1 and Q2. A first terminal of the electronic switch Q1 is connected to a pin N of the platform controller 90. A second terminal of the electronic switch Q1 is connected to a power input terminal P3V3_AUX. A third terminal of the electronic switch Q1 is connected to a pin 1 of the connector 20. A first terminal of the electronic switch Q2 is connected to the pin P of the platform controller 90. A second terminal of the electronic switch Q2 is connected to a power input terminal P5V. A third terminal of the electronic switch Q2 is connected to the pin 1 of the connector 20. A pin 2 of the connector 20 is connected to a pin Y3 of the chip U2. The pin 2 of the connector 20 is also connected to a pin Y2 of the chip U2. A pin 3 of the connector 20 is connected to a pin Y1 of the chip U2. The pin 3 of the connector 20 is also connected to a pin Y4 of the chip U2. A pin 4 of the connector 20 is grounded.

When the connector 20 is connected to a first external device which uses a system management bus to communicate with the baseboard controller 80, the platform controller 90 outputs a high level signal through the pin P and a low level signal through the pin N. The electronic switch Q2 is turned off when the first terminal of the electronic switch Q2 receives the high level signal. The electronic switch Q1 is turned on when the first terminal of the electronic switch Q1 receives the low level signal. The power input terminal P3V3_AUX supplies power to the pin 1 of the connector 20. The pin A1 of the chip U2 is connected to the pin Y1 of the chip U2 when the pin OE1 of the chip U2 is at a low level. The pin A2 of the chip U2 is connected to the pin Y2 of the chip U2 when the pin OE2 is at a low level. The pin A3 of the chip U2 is disconnected from the pin Y3 of the chip U2 when the pin OE3 is at a high level. The pin A4 of the chip U2 is disconnected from the pin Y4 of the chip U2 when the pin 0E4 is at a high level. The connector 20 is connected to the baseboard controller 80. The first external device communicates with the baseboard controller 80 through the connector 20.

When the connector 20 is coupled to a second external device which communicates with the platform controller 90, the platform controller 90 outputs a high level signal through the pin N and a low level signal through the pin P. When the electronic switch Q1 is turned off, the electronic switch Q2 is turned on. The power input terminal P5V supplies power to the pin 1 of the connector 20. The pin A1 is disconnected from the pin Y1 when the pin OE1 is at a high level. The pin A2 is disconnected from the pin Y2 when the pin 0E2 is at a high level. The pin A3 is connected to the pin Y3 when the pin OE3 is at a low level. The pin A4 is connected to the pin Y4 when the pin OE3 is at a low level. The second external device communicates with the platform controller 90 through the connector 20.

In the embodiment, the electronic switches Q1 and Q2 are p-channel field effect transistors.

While the disclosure has been described by way of example and in terms of an embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A motherboard, comprising:
a first connector selectively connected to a first external device and a second external device;
a first signal module to communicate with the first external device, wherein the first signal module outputs a first signal when the first connector is connected to the first external device, the first signal module outputs a second signal when the first connector is connected to the second external device;
a second signal module to communicate with the second external device;
a switch module connected to the first connector, the first signal module, and the second signal module, wherein the switch module connects the first signal module to the first connector and disconnects the second signal module from the first connector when the switch module receives the first signal, and the switch module connects the second signal module to the first connector and disconnects the first signal module from the first connector when the switch module receives the second signal; and
a power module connected to the first signal module and the first connector, wherein the power module outputs a first voltage to the first connector when the power module receives the first signal, and the power module outputs a second voltage to the first connector when the power module receives the second signal.

2. The motherboard of claim 1, wherein the switch module further comprises a chip, the first signal module comprises a platform controller, the second signal module comprises a baseboard controller, a first control pin and a second control pin of the chip are connected to a first pin of the platform controller, a third control pin and a fourth control pin of the chip are connected to a second pin of the platform controller, a first pin of the baseboard controller is connected to a first input pin of the chip, a second pin of the baseboard controller is connected to a second input pin of the chip, a third pin of the platform controller is connected to a third input pin of the chip, a fourth pin of the platform controller is connected to a fourth input pin of the chip, a second output pin and a third output pin of the chip are connected to a second pin of the first connector, the first output pin is connected to a third pin of the first connector, and a fourth output pin is connected to a third pin of the first connector, the first input pin of the chip is connected to the first output pin of the chip when the first control pin of the chip is at a low level, the first input pin of the chip is disconnected from the first output pin of the chip when the first control pin of the chip is at a high level, the second input pin of the chip is connected to the second output pin of the chip when the second control pin of the chip is at a low level, the second input pin of the chip is disconnected from the second output pin of the chip when the second control pin of the chip is at a high level, the third input pin of the chip is connected to the third output pin of the chip when the third control pin of the chip is at a low level, the third input pin of the chip is disconnected from the third output pin of the chip when the third control pin of the chip is at a high level, the fourth input pin of the chip is connected to the fourth output pin of the chip when the fourth control pin of the chip is at a low level, and the fourth input pin of the chip is disconnected from the fourth output pin of the chip when the fourth control pin of the chip is at high level.

3. The motherboard of claim 2, wherein the power module comprises a first electronic switch and a second electronic switch, a first terminal of the first electronic switch is connected to the first pin of the platform controller, a second terminal of the first electronic switch is connected to the first power input terminal, a third terminal of the first electronic switch is connected to the first pin of the first connector, a first terminal of the second electronic switch is connected to the second pin of the platform controller, a second terminal of the second electronic switch is connected to a second power input terminal, a third terminal of the second electronic switch is connected to the first pin of the first connector, the first and second electronic switches are turned on when the first terminals are at a low level, and the first and second electronic switches are turned off when the first terminals are at a high level.

4. The motherboard of claim 3, wherein the first and second electronic switches are p-channel field effect transistors.
